(19) United States
(12) Patent Application Publication
(10) Pub. No.: US 2023/0411133 A1
(43) Pub. Date: Dec. 21, 2023

(54) SAMPLE SUPPORT, IONIZATION METHOD, AND MASS SPECTROMETRY METHOD

(71) Applicant: HAMAMATSU PHOTONICS K.K., Hamamatsu-shi, Shizuoka (JP)

(72) Inventors: Masahiro KOTANI, Hamamatsu-shi, Shizuoka (JP); Takayuki OHMURA, Hamamatsu-shi, Shizuoka (JP); Akira TASHIRO, Hamamatsu-shi, Shizuoka (JP)

(73) Assignee: HAMAMATSU PHOTONICS K.K., Hamamatsu-shi, Shizuoka (JP)

(21) Appl. No.: 18/037,346

(22) PCT Filed: Oct. 14, 2021
(86) PCT No.: PCT/JP2021/038075

§ 371 Date: May 17, 2023

(30) Foreign Application Priority Data
Dec. 14, 2020 (JP) 2020-206539

(51) Int. Cl. H01J 49/04

(52) U.S. Cl. CPC H01J 49/0409

(57) ABSTRACT

A sample support body includes a substrate and a porous layer provided on the substrate and having a surface opposite the substrate. The porous layer includes a body layer having a plurality of holes open to a surface of the porous layer. Each of the plurality of holes includes an extension portion extending in a thickness direction of the substrate and an opening widened from an end of the extension portion on a surface side toward the surface. An average value of the depths of the plurality of holes is 3 μm or more and 100 μm or less. A value obtained by dividing the average value of the depths by an average value of the widths of the plurality of holes is 9 or more and 2500 or less.

### TECHNICAL FIELD

The present disclosure relates to a sample support body, an ionization method, and a mass spectrometry method.

### BACKGROUND ART

Patent Literature 1 discloses a sample support body including a substrate provided with a plurality of through holes. The sample support body disclosed in Patent Literature 1 is used, as one application, in imaging mass spectrometry for imaging a two-dimensional distribution of molecules constituting a sample. However, in the sample support body disclosed in Patent Literature 1, a thickness of the substrate may be about several μm, and in such some cases, when pressing the substrate against the sample and transferring components of the sample to the substrate, care is required to be taken in handling so as not to break the substrate.

Patent Literature 2 discloses a sample target including a layer of aluminum and a layer of porous alumina provided on the layer of aluminum. In the sample target disclosed in Patent Literature 2, for example, when the layer of aluminum is thickened, it is considered that the layer of porous alumina is less likely to break.

### CITATION LIST

### Patent Literature

Patent Literature 1: Japanese Patent No. 6093492
Patent Literature 2: Japanese Patent No. 4885142

### SUMMARY OF INVENTION

### Technical Problem

However, the sample target disclosed in Patent Literature 2 is intended for application to mass spectrometry, and cannot be said to be intended for application to imaging mass spectrometry.

Accordingly, an object of the present disclosure is to provide a sample support body that is easy to handle and suitable for imaging mass spectrometry and an ionization method and a mass spectrometry method using such a sample support body.

### Solution to Problem

A sample support body according to one aspect of the present disclosure is a sample support body used for ionizing components of a sample, including: a substrate; and a porous layer provided on the substrate and having a surface opposite to the substrate, in which the porous layer includes a body layer having a plurality of holes open to the surface, in which each of the plurality of holes includes: an extension portion extending in a thickness direction of the substrate; and an opening widened from an end of the extension portion on a surface side toward the surface, in which an average value of depths of the plurality of holes is 3 μm or more and 100 μm or less, and in which a value obtained by dividing the average value of the depths by an average value of widths of the plurality of holes is 9 or more and 2500 or less.

In the sample support body, the porous layer is provided on the substrate. Accordingly, for example, even when the surface of the porous layer is pressed against the sample in order to transfer the components of the sample to the surface of the porous layer, since the porous layer is unlikely to be broken, the sample support body can be easy to handle. In addition, since the average value of the depths of the plurality of holes is 3 μm or more and 100 μm or less and the value obtained by dividing the average value of the depths by the average value of the widths of the plurality of holes is 9 or more and 2500 or less, excess liquid (moisture or the like) contained in the sample can easily escape into the plurality of holes. Furthermore, since each of the plurality of holes includes the opening widened toward the surface of the porous layer, the components of the sample are likely to remain on the surface side of the porous layer, and the irradiation area of the energy rays for ionizing the components of the sample increases. Accordingly, for example, by irradiating the surface of the porous layer with the energy rays, the components of the sample can be ionized with high efficiency while maintaining the position information (two-dimensional distribution information of the molecules constituting the sample) of the sample components. As described above, the sample support body is easy to handle and suitable for imaging mass spectrometry.

In the sample support body according to one aspect of the present disclosure, the average value of the widths may be 40 nm or more and 350 nm or less. Accordingly, the structure in which excess liquid contained in the sample easily escapes into the plurality of holes and the components of the sample easily remain on the surface side of the porous layer can reliably and easily be obtained.

In the sample support body according to one aspect of the present disclosure, the body layer may be an insulating layer, and the porous layer may further include a conductive layer formed along at least the surface and an inner surface of the opening. Accordingly, by irradiating the surface (that is, the conductive layer) of the porous layer with the energy rays, the components of the sample can be ionized with high efficiency while maintaining the position information of the components of the sample.

In the sample support body according to one aspect of the present disclosure, the conductive layer may have a thickness of 10 nm or more and 200 nm or less. Accordingly, the components of the sample can be ionized with high efficiency by adjusting a resistance value of the conductive layer.

In the sample support body according to one aspect of the present disclosure, the body layer may be an insulating layer, and the body layer may be exposed to an outside at least on the surface and an inner surface of the opening. Accordingly, by irradiating the surface of the porous layer (that is, the body layer that is an insulating layer) with charged-droplets, the components of the sample can be ionized with high efficiency while maintaining the position information of the components of the sample.

In the sample support body according to one aspect of the present disclosure, the substrate and the body layer may be formed by anodizing a surface layer of a metal substrate or a silicon substrate. Accordingly, the structure in which excess liquid contained in the sample easily escapes into the plurality of holes and the components of the sample easily remain on the surface side of the porous layer can reliably and easily be obtained.

An ionization method according to one aspect of the present disclosure includes processes of: a process of preparing the sample support body in which the porous layer includes the conductive layer; a process of arranging the sample on the surface; and a process of ionizing the components by irradiating the surface with energy rays.

According to the ionization method, as described above, the components of the sample can be ionized with high efficiency while maintaining the position information of the components of the sample.

An ionization method according to one aspect of the present disclosure includes processes of: a process of preparing the sample support body in which the body layer which is the insulating layer is exposed to an outside in the porous layer; a process of arranging the sample on the surface; and a process of ionizing the components by irradiating the surface with charged-droplets.

According to the ionization method, as described above, it is possible to ionize the components of the sample with high efficiency while maintaining the position information of the components of the sample.

A mass spectrometry method according to one aspect of the present disclosure includes a plurality of processes included in the ionization method and a process of detecting the ionized components.

According to the mass spectrometry method, the two-dimensional distribution of molecules constituting the sample can be imaged with high sensitivity.

### Advantageous Effects of Invention

According to the present disclosure, it is possible to provide a sample support body that is easy to handle and suitable for imaging mass spectrometry and an ionization method and a mass spectrometry method using the sample support body.

### BRIEF DESCRIPTION OF DRAWINGS

FIG. 1 is a plan view of a sample support body of one embodiment.

FIG. 2 is a cross-sectional view of the sample support body taken along line II-II illustrated in FIG. 1.

FIG. 3 is a cross-sectional view of a porous layer illustrated in FIG. 2.

FIG. 4 are diagrams illustrating a process of manufacturing the sample support body illustrated in FIG. 2.

FIG. 5 are diagrams illustrating a process of forming a body layer illustrated in FIG. 3.

FIG. 6 is a diagram illustrating an SEM image of a surface of the body layer as an example.

FIG. 7 is a diagram illustrating the SEM image of a cross section of the porous layer as an example.

FIG. 8 are diagrams illustrating an ionization method and a mass spectrometry method using the sample support body illustrated in FIG. 1.

FIG. 9 are optical images of a brain portion of a mouse, and “images illustrating a two-dimensional distribution of m/z 848.6” of the brain portion of the mouse.

FIG. 10 illustrates an optical image of the brain portion of the mouse, an “image illustrating a two-dimensional distribution of m/z 756.6” of the brain portion of the mouse, an “image illustrating the two-dimensional distribution of m/z 832.6” of the brain portion of the mouse, and an “image illustrating the two-dimensional distribution of m/z 834.6” of the brain portion of the mouse.

FIG. 11 are graphs illustrating a relationship between an m/z value and an intensity.

FIG. 12 are diagrams illustrating a process of manufacturing a sample support body according to Modified Example.

### DESCRIPTION OF EMBODIMENTS

Hereinafter, embodiments of the present disclosure will be described in detail with reference to the drawings. It is noted that, in each figure, the same or corresponding components are denoted by the same reference numerals, and redundant descriptions are omitted.

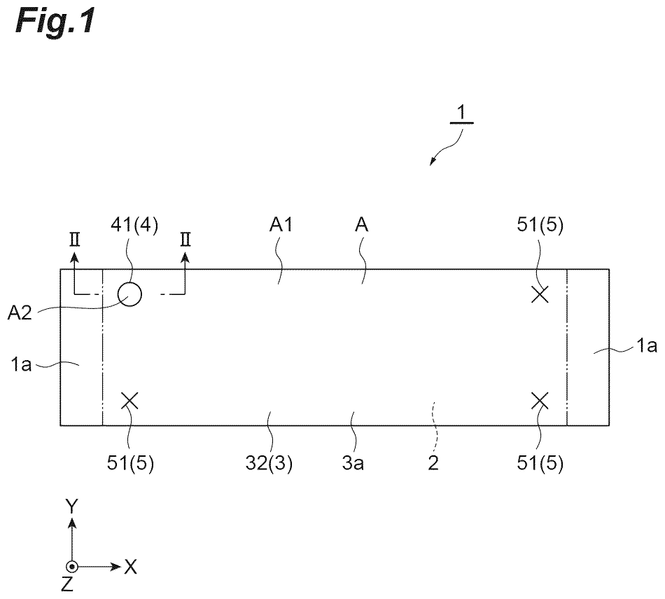

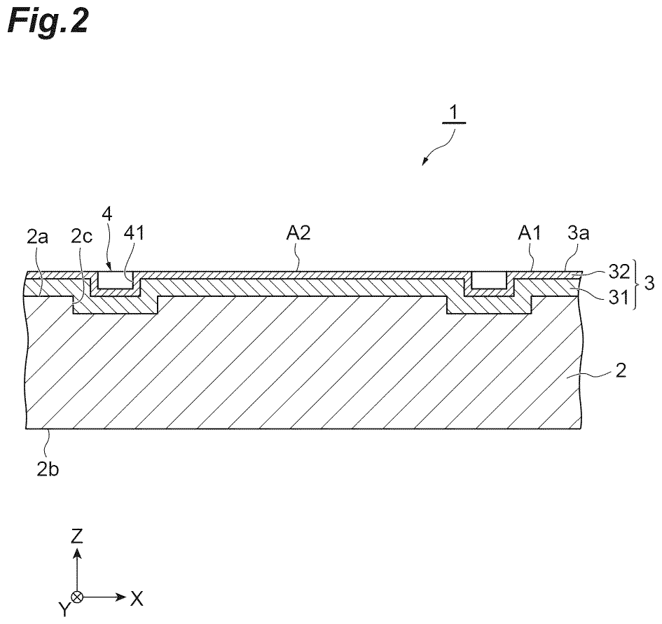

As illustrated in FIGS. 1 and 2, a sample support body 1 has a substrate 2 and a porous layer 3. The sample support body 1 is used for ionizing components of the sample. Hereinafter, a thickness direction of the substrate 2 is referred to as a Z-axis direction, one direction perpendicular to the Z-axis direction is referred to as an X-axis direction, and a direction perpendicular to both the Z-axis direction and the X-axis direction is referred to as a Y-axis direction.

The substrate 2 has a front surface 2a and a back surface 2b perpendicular to the Z-axis direction. A shape of the substrate 2 is, for example, a rectangular plate shape of which longitudinal direction is the X-axis direction. A thickness of the substrate 2 is, for example, approximately 0.5 to 1 mm A material of the substrate 2 is, for example, aluminum (Al).

The porous layer 3 is provided on the substrate 2. Specifically, the porous layer 3 is formed over the entire surface 2a of the substrate 2. The porous layer 3 has a surface 3a on the opposite side of the substrate 2. The porous layer 3 includes a body layer 31 that is an insulating layer. A material of the body layer 31 is, for example, alumina (Al₂O₃).

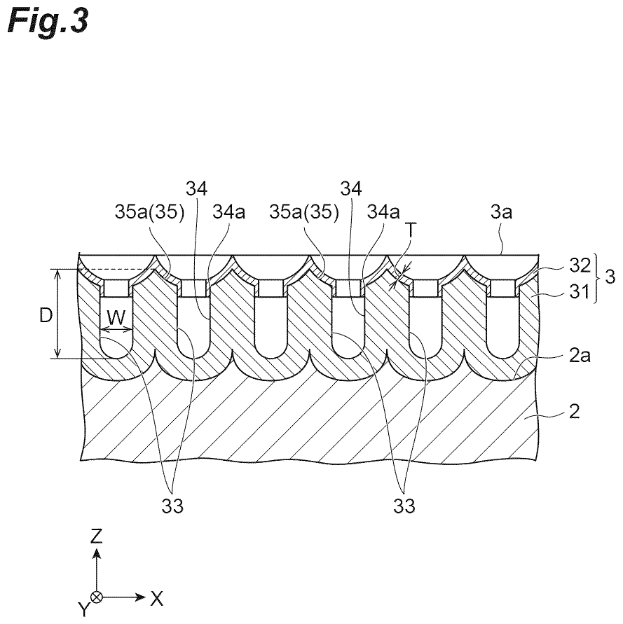

As illustrated in FIG. 3, the body layer 31 has a plurality of holes 33 opening to the surface 3a. Each hole 33 includes an extension portion 34 and an opening 35. The extension portion 34 extends in the Z-axis direction. A shape of the extension portion 34 when viewed from the Z-axis direction is, for example, a circular shape. The opening 35 is widened from an end 34a of the extension portion 34 on the side of the surface 3a toward the surface 3a. A shape of the opening 35 is, for example, a bowl shape or a truncated cone shape (tapered shape) expanding from the end 34a of the extension portion 34 toward the surface 3a. It is noted that the end of the extension portion 34 on the side of the substrate 2 is positioned inside the body layer 31.

The porous layer 3 further includes a conductive layer 32. The conductive layer 32 is formed along at least the surface 3a and an inner surface 35a of each opening 35 of the porous layer 3. In the sample support body 1, a material of the conductive layer 32 is a metal having low affinity (reactivity) with the sample and high conductivity. Examples of such metals include Au (gold), Pt (platinum), Cr (chromium), Ni (nickel), and Ti (titanium).

As illustrated in FIG. 1, both ends 1a of the sample support body 1 in the X-axis direction (both ends outside a chain double-dashed line in FIG. 1) function as held portions, for example, when the sample support body 1 is mounted in a mass spectrometer. A region A between both ends 1a of the surface 3a of the porous layer 3 functions as a measurement region. The region A has, for example, a rectangular shape of which longitudinal direction is the X-axis direction.

The sample support body 1 further includes a partition portion 4 and a plurality of display portions 5. The partition portion 4 is arranged, for example, at one corner of the region A. Each display portion 5 is arranged, for example, at each of the three corners of the region A (three corners where the partition portion 4 is not arranged).

The partition portion 4 includes a partition groove 41 extending in an annular shape. The partition groove 41 is formed on the surface 3a of the porous layer 3 so as to pass between a first region A1 and a second region A2. The first region A1 is a region of the region A outside the partition groove 41. The second region A2 is a region of the region A inside the partition groove 41. The partition portion 4 partitions the region A into the first region A1 and the second region A2.

As illustrated in FIG. 2, the partition groove 41 is formed on the surface 3a of the porous layer 3 by falling the porous layer 3 into a groove 2c formed on the surface 2a of the substrate 2. The width of the partition groove 41 is larger than the depth of the partition groove 42. As an example, the depth of the partition groove 41 is 50 μm or more and 300 μm or less, and the width of the partition groove 41 is twice or more the depth of the partition groove 41.

As illustrated in FIG. 1, each display portion 5 includes a display groove 51 extending in an X shape. The display groove 51 is formed on the surface 3a of the porous layer 3 so as to display predetermined information. Similarly to the partition groove 41, the display groove 51 is formed on the surface 3a of the porous layer 3 by falling the porous layer 3 into the grooves formed on the surface 2a of the substrate 2. For the sample support body 1, the predetermined information is information about the position and angle of the sample support body 1 when the sample support body 1 is mounted in the mass spectrometer, and for example, the predetermined information is used for alignment of the sample support body 1 when the sample support body 1 is mounted in the mass spectrometer.

The dimensions of the porous layer 3 will be described. As illustrated in FIG. 3, the average value of depths D of the plurality of holes 33 is 3 μm or more and 100 μm or less. As an example, in the region A, the number of holes 33 having the depth D of which the average value is ±10% is 60% or more (preferably 70% or more, more preferably 80% or more) of the total number of holes 33. The average value of widths W of the plurality of holes 33 is 40 nm or more and 350 nm or less. As an example, in the region A, the number of holes 33 having the width W of which the average value is ±10% is 60% or more (preferably 70% or more, more preferably 80% or more) of the total number of holes 33. The value obtained by dividing the average value of the depths D by the average value of the widths W is 9 or more and 2500 or less. As an example, in the region A, the number of holes 33 having “the obtained by dividing the average value of the depths D by the average value of the widths W” of the average value of ±10% is 60% or more (preferably 70% or more, more preferably 80% or more) of the total number of the holes 33. The thickness T of the conductive layer 32 is 10 nm or more and 200 nm or less.

The average value of depths D is a value obtained as follows. First, the sample support body 1 is prepared and cut parallel to the Z-axis direction. Subsequently, an SEM image of one of the cut surfaces of the body layer 31 is obtained. Subsequently, in the region corresponding to the region A, the average value of the depths D of the plurality of holes 33 is calculated to obtain the average value of the depths D.

The average value of widths W is the value obtained as follows. First, the sample support body 1 is prepared, and the sample support body 1 (specifically, the body layer 31) is cut perpendicularly to the Z-axis direction so as to traverse the plurality of extension portions 34. Subsequently, an SEM image of one of the cut surfaces of the body layer 31 is obtained. Subsequently, in the region corresponding to the region A, the plurality of pixel groups corresponding to the plurality of holes 33 (specifically, the plurality of extension portions 34) are extracted. The extraction of the pixel groups is performed, for example, by performing a binarization process on an SEM image. Subsequently, by calculating the diameter of a circle having an average value of the areas of the plurality of holes 33 (specifically, the plurality of extension portions 34), the diameter is obtained as the average value of the widths W based on the plurality of pixel groups.

The substrate 2 and the body layer 31 are formed by anodizing the surface layer of the metal substrate. The substrate 2 and the body layer 31 are formed, for example, by anodizing the surface layer of the Al substrate. It is noted that, in addition to an Al substrate, as a metal substrate, a tantalum (Ta) substrate, a niobium (Nb) substrate, a titanium (Ti) substrate, a hafnium (Hf) substrate, a zirconium (Zr) substrate, a zinc (Zn) substrate, a tungsten (W) substrate, a bismuth (Bi) substrate, an antimony (Sb) substrate, and the like are exemplified.

The plurality of holes 33 each having a substantially constant width W are formed uniformly (distributed uniformly) in the body layer 31. The pitch (distance between center lines) of the adjacent holes 33 is, for example, about 275 nm. It is preferable that an aperture ratio (a ratio of the plurality of holes 33 to the region A when viewed from the Z-axis direction) of the plurality of holes 33 in the region A is practically 10 to 80%, particularly 60 to 80%. It is noted that, in the plurality of holes 33, the width W of each hole 33 may be uneven, or the holes 33 may be partially connected to each other.

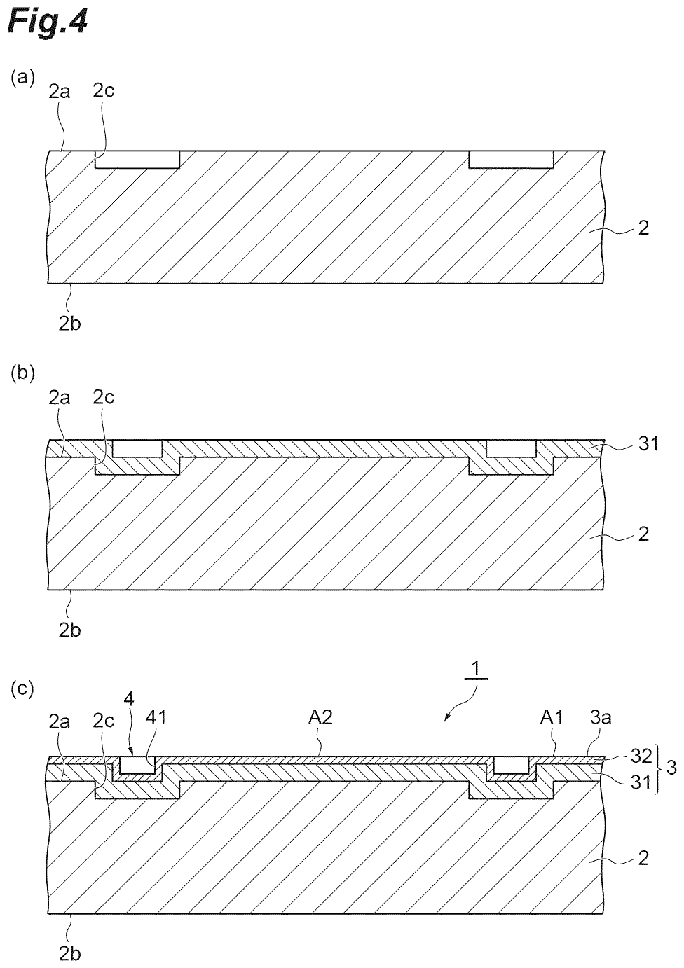

The method for manufacturing the sample support body 1 will be described. First, as illustrated in (a) of FIG. 4, the substrate 2 is prepared, and the groove 2c for the partition portion 4 is formed on the surface 2a of the substrate 2. At this time, the grooves for the plurality of display portions 5 illustrated in FIG. 1 are also formed on the surface 2a of the substrate 2. For example, etching, laser processing, machining, or the like is used for forming the grooves 2c for the partition portion 4 and the grooves for the plurality of display portions 5.

Subsequently, as illustrated in (b) of FIG. 4, the body layer 31 is formed in the surface 2a of the substrate 2. Subsequently, as illustrated in (c) of FIG. 4, the conductive layer 32 is formed on the body layer 31. For example, an evaporation method, a sputtering method, a plating method, an atomic layer deposition (ALD) method, or the like is used for forming the conductive layer 32.

As described above, the sample support body 1 is obtained. In the method for manufacturing the sample support body 1 described above, the partition grooves 41 are formed on the surface 3a of the porous layer 3 by falling the porous layer 3 into the grooves 2c for the partition portion 4. Further, the plurality of display grooves 51 illustrated in FIG. 1 are formed on the surface 3a of the porous layer 3 by falling the porous layer 3 into the grooves for the plurality of display portions 5.

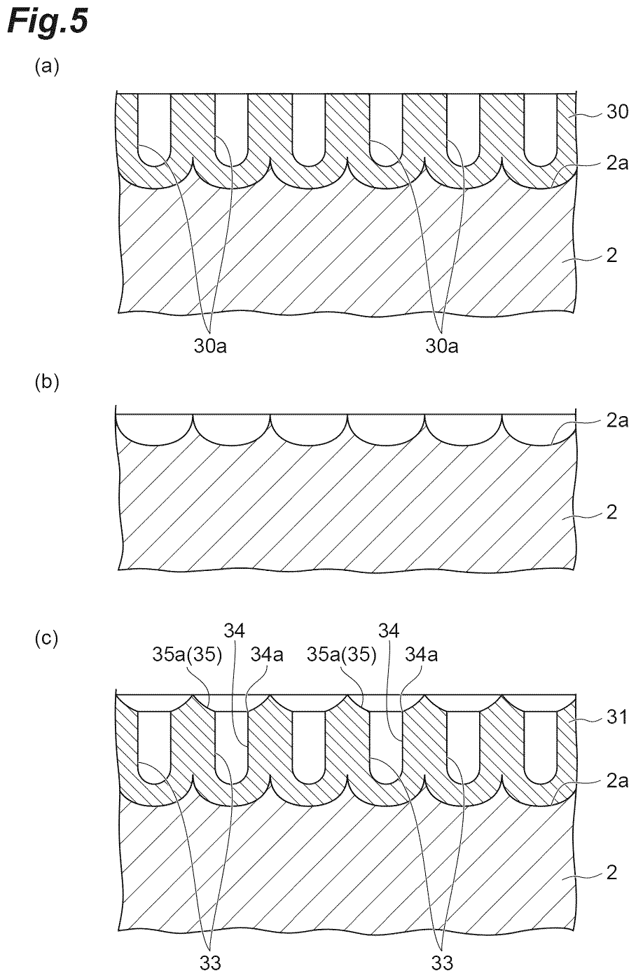

Formation of the body layer 31 will be described. First, as illustrated in (a) of FIG. 5, the substrate 2 is prepared, and the oxide layer 30 is formed on the surface 2a of the substrate 2 by anodizing the surface layer of the substrate 2. The oxide layer 30 has a plurality of holes 30a that open on the side opposite to the substrate 2. Subsequently, as illustrated in (b) of FIG. 5, the surface 2a of the substrate 2 is exposed to the outside by removing the oxide layer 30. A plurality of bowl-shaped or truncated-cone-shaped (tapered) recesses are formed on the surface 2a of the substrate 2. The plurality of recesses are formed at positions corresponding to the plurality of holes 30a.

Subsequently, as illustrated in (c) of FIG. 5, the body layer 31 is formed on the surface 2a of the substrate 2 by anodizing the surface layer of the substrate 2 again. In the body layer 31, each hole 33 includes the opening 35 widened from the end 34a of the extension portion 34 toward the side opposite to the substrate 2. The opening 35 is formed in each hole 33 by performing anodization in two stages as described above. In addition, since the anodization is performed in two stages, the regularity and uniformity of the arrangement and shape of the plurality of holes 33 are improved. It is noted that, in the formation of the body layer 31 described above, the substrate 2 is an Al substrate, and the oxide layer 30 and the body layer 31 are Al₂O₃ layers.

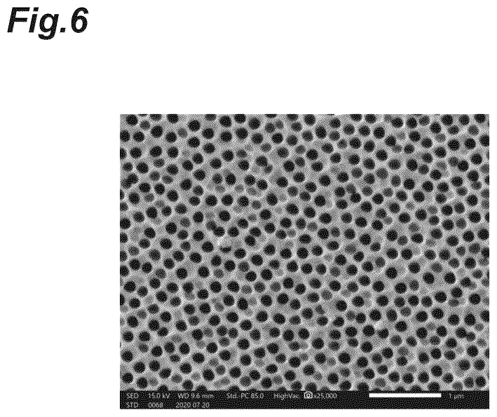

FIG. 6 is a diagram illustrating an SEM image of the surface (surface on the opening 35 side) of the body layer 31 as an example. The body layer 31 illustrated in FIG. 6 is formed by anodizing the surface layer of the Al substrate in two stages. In the body layer 31 illustrated in FIG. 6, the average value of the widths W of the plurality of holes 33 (black portion) is 110 nm, the average value of the depths D of the plurality of holes 33 is 10 μm, and the value obtained by dividing the average value of the depths D by the average value of the widths W is 91.

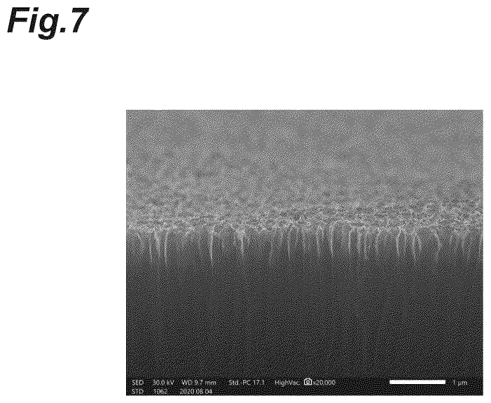

FIG. 7 is a diagram illustrating an SEM image of a cross section (cross section parallel to the Z-axis direction) of the porous layer 3 as an example. The porous layer 3 illustrated in FIG. 7 is formed by performing evaporation of Pt on the surface (surface on the opening 35 side) of the body layer 31. Here, while rotating the body layer 31, the evaporation of Pt from the direction inclined at 30 degrees with respect to the direction perpendicular to the surface of the body layer 31 is performed. In the porous layer 3 illustrated in FIG. 7, the thickness T of the conductive layer 32 is 50 nm, and the amount of penetration of the conductive layer 32 (width of the “range in which the conductive layer 32 is formed” in the direction perpendicular to the surface of the body layer 31) is 506 nm. In the porous layer 3 illustrated in FIG. 7, since each hole 33 includes the opening 35, it is considered that the amount of penetration of the conductive layer 32 is sufficiently ensured with respect to the thickness T of the conductive layer 32.

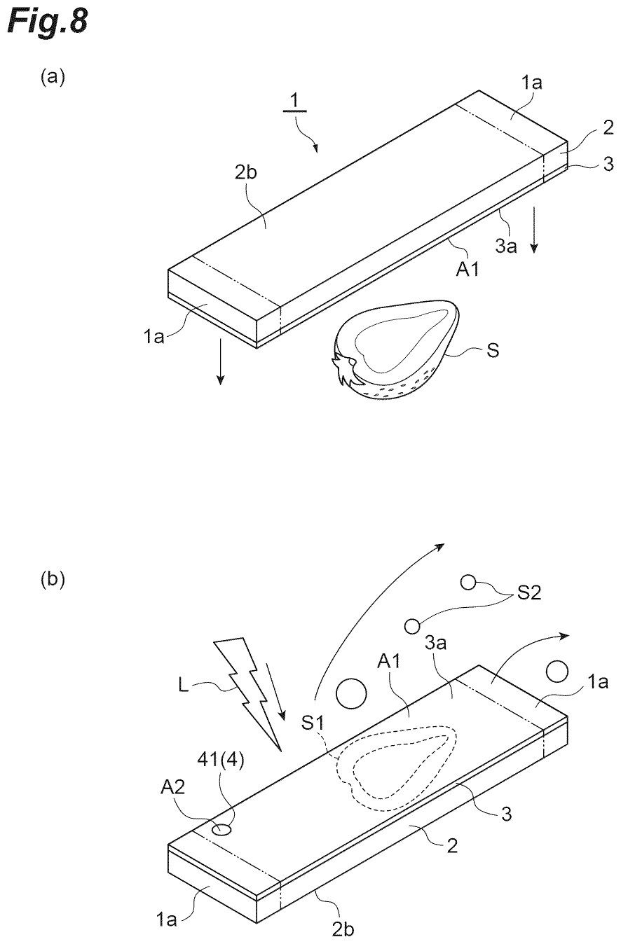

The ionization method and the mass spectrometry method using the sample support body 1 will be described. First, as illustrated in (a) of FIG. 8, the sample support body 1 is prepared (preparing process). Subsequently, the sample S is arranged in the surface 3a of the porous layer 3 of the sample support body 1 (arrangement process). As an example, the first region A1 of the surface 3a is pressed against the sample S to transfer the components of the sample S to the first region A1 of the surface 3a.

Subsequently, the sample support body 1 is mounted in the mass spectrometer, and as illustrated in (b) of FIG. 8, the surface 3a of the porous layer 3 of the sample support body 1 is irradiated with laser beams (energy rays) L, while applying a voltage to the conductive layer 32 of the sample support body 1 (refer to FIG. 1). Accordingly, components S1 of the sample S arranged on the surface 3a is ionized (ionization process). As an example, the components S1 of the sample S arranged on the surface 3a are scanned with the laser beams L. The above-described processes correspond to the ionization method using the sample support body 1. An example of the ionization method described above is implemented as the surface-assisted laser desorption/ionization (SALDI) method.

Subsequently, sample ions (ionized components) S2 released by the ionization of the components S1 of the sample S are detected in the mass spectrometer (detection process), and imaging mass spectrometry of imaging the two-dimensional distribution of the molecules constituting the sample S is performed. As an example, the mass spectrometer is a scanning mass spectrometer using time-of-flight mass spectrometry (TOF-MS). The above-described processes correspond to the mass spectrometry method using the sample support body 1. It is noted that the second region A2 is used, for example, as a region onto which the reagent for mass calibration is dropped.

As described above, the sample support body 1 is provided with the porous layer 3 on the substrate 2. As a result, for example, even when the surface 3a of the porous layer 3 is pressed against the sample S in order to transfer the components S1 of the sample S to the surface 3a of the porous layer 3, since the porous layer 3 is unlikely to be broken, the sample support body 1 can be easy to handle. Further, the average value of the depths D of the plurality of holes 33 is 3 μm or more and 100 μm or less, and the value obtained by dividing the average value of the depths D by the average value of the widths W of the plurality of holes 33 is 9 or more and 2500 or less, excess liquid (moisture or the like) contained in the sample S can easily escape into the plurality of holes 33. Furthermore, since each hole 33 includes the opening 35 widened toward the surface 3a of the porous layer 3, the components S1 of the sample S are likely to remain on the surface 3a side of the porous layer 3, and additionally, the irradiation area of the laser beams L for ionizing the components S1 of the sample S increases. Accordingly, for example, by irradiating the surface 3a of the porous layer 3 with the laser beams L, the position information (the two-dimensional distribution information of the molecules constituting the sample S) of the components S1 of the sample S can be maintained and the components S1 of the sample S can be ionized with high efficiency. As described above, the sample support body 1 is easy to handle and suitable for imaging mass spectrometry.

In the sample support body 1, the average value of the widths W of the plurality of holes 33 is 40 nm or more and 350 nm or less. As a result, the structure in which excess liquid contained in the sample S easily escapes into the plurality of holes 33 and the components S1 of the sample S easily remain on the surface 3a side of the porous layer 3 can reliably and easily be obtained.

In the sample support body 1, the body layer 31 is an insulating layer, and the porous layer 3 includes the conductive layer 32 formed along at least the surface 3a of the porous layer 3 and the inner surface of each opening 35. Thus, by irradiating the surface 3a (that is, the conductive layer 32) of the porous layer 3 with the laser beams L, the components S1 of the sample S can be ionized with high efficiency while maintaining the position information of the components S1 of the sample S.

In the sample support body 1, the thickness of the conductive layer 32 is 10 nm or more and 200 nm or less. Accordingly, the components S1 of the sample S can be ionized with high efficiency by adjusting the resistance value of the conductive layer 32.

In the sample support body 1, the substrate 2 and the body layer 31 are formed by anodizing the surface layer of the metal substrate. As a result, the structure in which excess liquid contained in the sample S easily escapes into the plurality of holes 33 and the components S1 of the sample S easily remain on the surface 3a side of the porous layer 3 can reliably and easily be obtained. In particular, in the sample support body 1, the regularity and uniformity of the arrangement and shape of the plurality of holes 33 are improved by anodizing in two stages. As a result, the efficiency (sensitivity) of ionizing the components S1 of the sample S in the region A can be suppressed from being varied.

According to the ionization method using the sample support body 1, the components S1 of the sample S can be ionized with high efficiency while maintaining the position information of the components S1 of the sample S as described above. According to the mass spectrometry method using the sample support body 1, the two-dimensional distribution of molecules constituting the sample S can be imaged with high sensitivity.

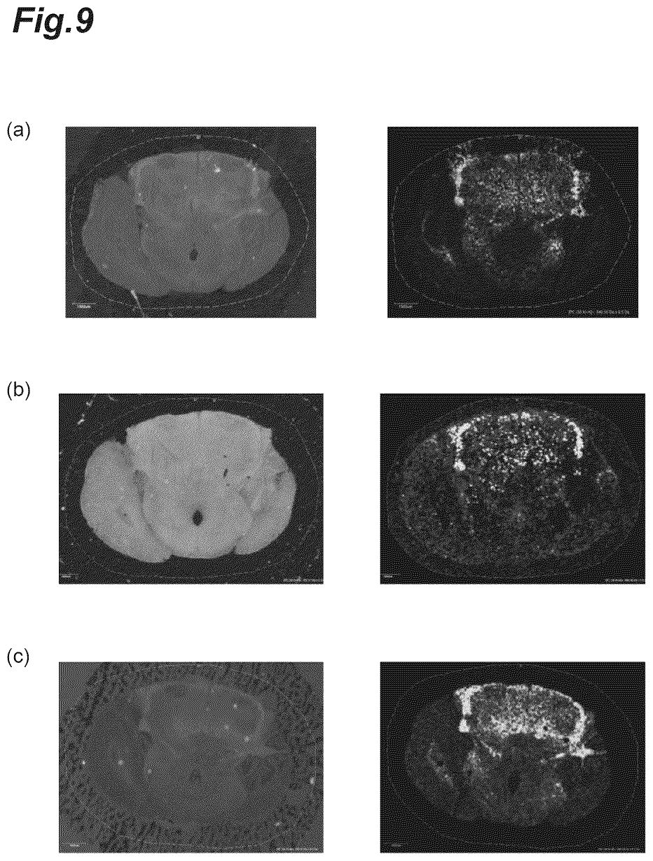

(a), (b) and (c) of FIG. 9 illustrate an optical image of the brain portion of the mouse (left side) and an “image illustrating the two-dimensional distribution of m/z 848.6” of the brain portion of the mouse (right side). (a) of FIG. 9 is the result of the case using the “sample support body 1 in which the average value of the widths W of the plurality of holes 33 is 110 μm, the average value of the depths D of the plurality of holes 33 is 10 μm, and the value obtained by dividing the average value of the depths D by the average value of the widths W is 91”. (b) of FIG. 9 is the result of the case using the “sample support body 1 in which the average value of the widths W of the plurality of holes 33 is 40 nm, the average value of the depths D of the plurality of holes 33 is 100 μm, and the value obtained by dividing the average value of the depths D by the average value of the widths W is 2500”. (c) of FIG. 9 is the result of the case using the “sample support body 1 in which the average value of the widths W of the plurality of holes 33 is 350 nm, the average value of the depths D of the plurality of holes 33 is 3 μm, and the value obtained by dividing the average value of the depths D by the average value of the widths W is 9”. In any cases, the two-dimensional distribution of m/z 848.6 can be fully confirmed.

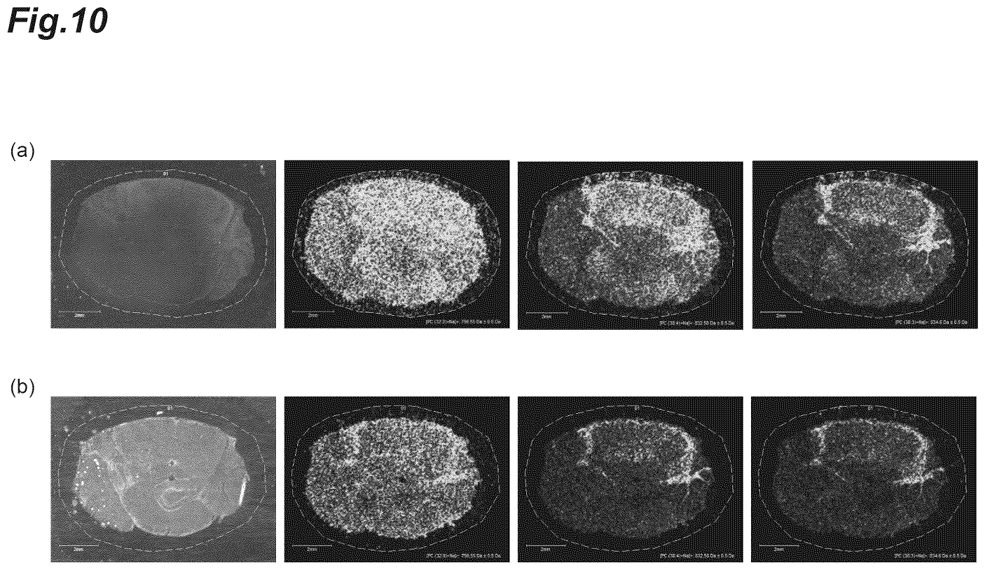

(a) and (b) of FIG. 10 illustrate an optical image of the brain portion of the mouse (left side), an “image illustrating the two-dimensional distribution of m/z 756.6” of the brain portion of the mouse (second from left), an “image illustrating the two-dimensional distribution of m/z 832.6” of the brain portion of the mouse (second from right), and an “image illustrating the two-dimensional distribution of m/z 834.6” of the brain portion of the mouse (right). (a) of FIG. 10 is the result of the case using the “sample support body 1 (Example) in which the average value of the widths W of the plurality of holes 33 is 100 nm, the average value of the depths D of the plurality of holes 33 is lam, the value obtained by dividing the average value of the depths D by the average value of the widths W is 100, and each hole 33 does not include the opening 35”. (b) of FIG. 10 is the result of the case using the “sample support body (Comparative Example) in which the average value of the widths W of the plurality of holes 33 is 100 nm, the average value of the depths D of the plurality of holes 33 is 10 lam, the value obtained by dividing the average value of the depths D by the average value of the widths W is 100, and each hole 33 does not include the opening 35”. With respect to the two-dimensional distribution of any m/z values, the two-dimensional distribution can be confirmed more clearly in the sample support body 1 of Example than in the sample support body of Comparative Example.

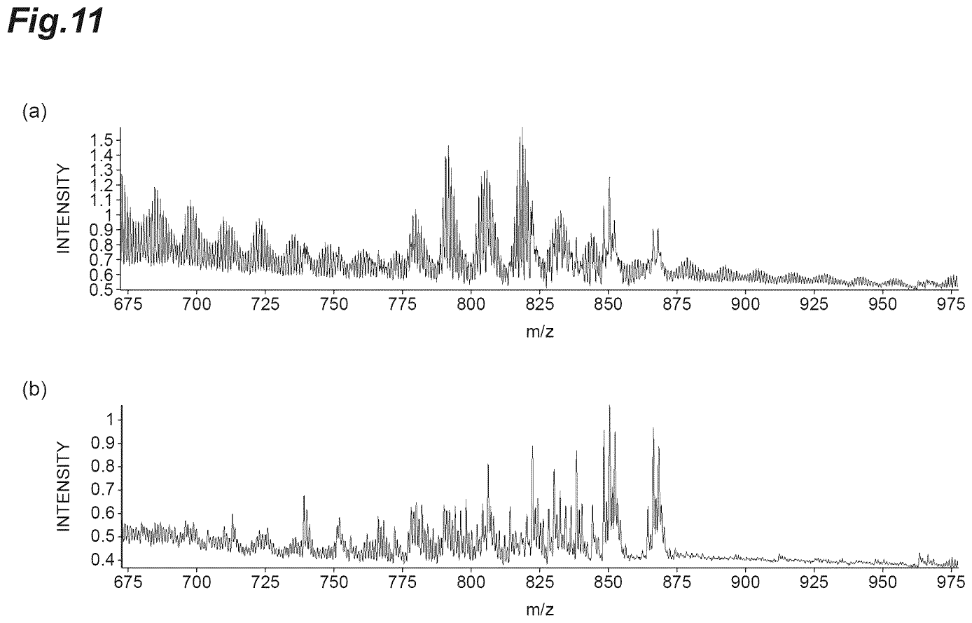

(a) of FIG. 11 is a graph illustrating a relationship between the m/z value and the intensity in the case of (a) of FIG. 10, and (b) of FIG. 11 is a graph illustrating a relationship between the m/z value and the intensity in the case of (b) of FIG. 10. As a result, the sensitivity of the sample support body 1 of Example is 1.65 times in average higher than that of the sample support body of Comparative Example.

The present disclosure is not limited to the embodiments described above. For example, the porous layer 3 may not include the conductive layer 32, and the body layer 31 that is an insulating layer may be exposed to the outside at least at the surface 3a of the porous layer 3 and the inner surface 35a of each opening 35. In that case, by irradiating the surface 3a (that is, the body layer 31, which is the insulating layer) of the porous layer 3 with charged-droplets, the position information of the components S1 of the sample S can be maintained, and the components S1 of the sample S can be ionized with high efficiency.

The ionization method and mass spectrometry method using the sample support body 1 in which the porous layer 3 does not include the conductive layer 32 are as follows. First, the sample support body 1 is prepared (preparing process). Subsequently, the sample S is arranged on the surface 3a of the porous layer 3 (that is, the surface of the body layer 31) of the sample support body 1 (arrangement process). Subsequently, in the mass spectrometer, the surface 3a of the porous layer 3 of the sample support body 1 is irradiated with charged-droplets to ionize the components S1 of the sample S (ionization process). As an example, the components S1 of the sample S arranged on the surface 3a are scanned with the charged-droplets. The above-described processes correspond to the ionization method using the sample support body 1. An example of the ionization method described above is implemented as a desorption electrospray ionization method (DESI). Subsequently, the sample ions S2 emitted by the ionization of the components S1 of the sample S are detected by the mass spectrometer (detection process), and imaging mass spectrometry is performed to image the two-dimensional distribution of the molecules constituting the sample S. The above-described processes correspond to the mass spectrometry method using the sample support body 1.

In any sample support body 1, when the average value of the depths D of the plurality of holes 33 is 3 μm or more and 100 μm or less and the value obtained by dividing the average value of the depths D by the average value of the widths W of the plurality of holes 33 is 9 or more and 2500 or less, the average value of the widths W may not be 40 nm or more and 350 nm or less. In that case, when the porous layer 3 includes the conductive layer 32, the thickness T of the conductive layer 32 may not be 10 nm or more and 200 nm or less.

In the sample support body 1 in which the porous layer 3 includes the conductive layer 32, the conductive layer 32 may reach the inner surface of the extension portion 34 at each hole 33.

The body layer 31 may be a conductive layer (for example, a metal layer or the like). In that case, the conductive layer 32 can be omitted from the porous layer 3.

The substrate 2 and the body layer 31 may be formed by anodizing the surface layer of the silicon (Si) substrate.

In the ionization using the sample support body 1 in which the porous layer 3 includes the conductive layer 32, the surface 3a of the porous layer 3 of the sample support body 1 may be irradiated with energy rays (for example, ion beams, electron beams, or the like) other than the laser beams L.

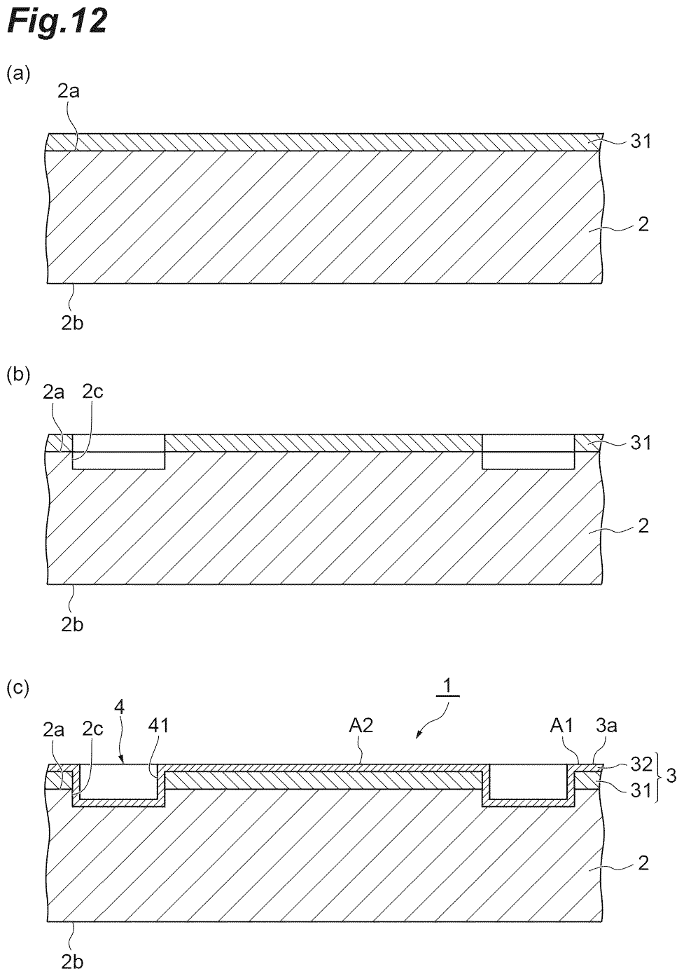

The partition portion 4 may be formed as follows. First, as illustrated in (a) of FIG. 12, the substrate 2 is prepared, and the body layer 31 is formed on the surface 2a of the substrate 2. Subsequently, as illustrated in (b) of FIG. 12, the groove 2c reaching the substrate 2 is formed on the body layer 31. Subsequently, as illustrated in (c) of FIG. 12, the conductive layer 32 is formed on the body layer 31. At this time, the conductive layer 32 is also formed on the inner surface of the groove 2c. According to the description above, the sample support body 1 is obtained. It is noted that the display portion 5 may also be formed in the same manner as the partition portion 4 is formed.

### REFERENCE SIGNS LIST

1: sample support body, 2: substrate, 3: porous layer, 3a: surface, 31: body layer, 32: conductive layer, 33: hole, 34: extension portion, 34a: end, 35: opening, 35a: inner surface, L: laser beams (energy ray), S: sample, S1: components, S2: sample ion (ionized components).

1: A sample support body for ionization of components of a sample, comprising:
a substrate; and
a porous layer provided on the substrate and having a surface opposite to the substrate,
wherein the porous layer includes a body layer having a plurality of holes open to the surface,
wherein each of the plurality of holes includes:
an extension portion extending in a thickness direction of the substrate; and
an opening widened from an end of the extension portion on a surface side toward the surface,
wherein an average value of depths of the plurality of holes is 3 μm or more and 100 μm or less, and
wherein a value obtained by dividing the average value of the depths by an average value of widths of the plurality of holes is 9 or more and 2500 or less.

2: The sample support body according to claim 1, wherein the average value of the widths is 40 nm or more and 350 nm or less.

3: The sample support body according to claim 1,
wherein the body layer is an insulating layer, and
wherein the porous layer further includes a conductive layer formed along at least the surface and an inner surface of the opening.

4: The sample support body according to claim 3, wherein the conductive layer has a thickness of 10 nm or more and 200 nm or less.

5: The sample support body according to claim 1,
wherein the body layer is an insulating layer, and
wherein the body layer is exposed to an outside at least on the surface and an inner surface of the opening.

6: The sample support body according to claim 3, wherein the substrate and the body layer are formed by anodizing a surface layer of a metal substrate or a silicon substrate.

7: An ionization method, comprising:
a process of preparing the sample support body according to claim 3;
a process of arranging the sample on the surface; and
a process of ionizing the components by irradiating the surface with energy rays.

8: An ionization method, comprising:
a process of preparing the sample support body according to claim 5;
a process of arranging the sample on the surface; and
a process of ionizing the components by irradiating the surface with charged-droplets.

9: A mass spectrometry method comprising:
a plurality of processes included in the ionization method according to claim 7; and
a process of detecting the ionized components.

10: A mass spectrometry method comprising:
a plurality of processes included in the ionization method according to claim 8; and
a process of detecting the ionized components.
